(19) United States
(12) Patent Application Publication
(10) Pub. No.: US 2015/0337801 A1
(43) Pub. Date: Nov. 26, 2015

(54) VANE DEVICE FOR A WIND TURBINE APPARATUS

(71) Applicant: Kuo-Chang HUANG, Tainan City (TW)

(72) Inventor: Kuo-Chang HUANG, Tainan City (TW)

(21) Appl. No.: 14/707,558

(22) Filed: May 8, 2015

(30) Foreign Application Priority Data
May 20, 2014 (TW) 103117664

(51) Int. Cl. F03D 7/02; F03D 1/06; F03D 1/04

(52) U.S. Cl. CPC F03D 7/0204; F03D 1/04; F03D 1/06

(57) ABSTRACT

A vane device includes a rotary shaft and a plurality of vane units angularly spaced apart from each other relative to the rotary shaft. Each of the vane units includes a grid frame that has grid spaces, and a plurality of vanes. Each of the vanes is disposed adjacent to a respective one of the grid spaces, and has a connecting end that is pivotally connected to the grid frame, and a swing end that is opposite to the connecting end. Each of the vanes is swingable between a cover position, where the swing end is adjacent to the grid frame to cover the respective one of the grid spaces, and an open position, where the swing end is away from the grid frame to uncover the respective one of the grid spaces.

### CROSS-REFERENCE TO RELATED APPLICATION

This application claims priority of Taiwanese Application No. 103117664, filed on May 20, 2014.

### FIELD

The disclosure relates to a vane device, and more particularly to a vane device for a wind turbine apparatus.

### BACKGROUND

Wind energy is one of the available forms of natural energy to be converted into electrical energy, and is more environmentally friendly compared with electrical energy coming from burning of fossil-fuel, such as petroleum or coal. The shape, outline and number of vanes of a wind turbine machine may affect the effectiveness of conversion from wind energy into electrical energy. A conventional vertical-axis wind turbine apparatus generally has elongated plate-like and nonperforated vanes. For vanes that can be propelled by wind blowing in a specific wind direction, a reverse wind flow may cause air resistance to hamper the movement of the vanes.

Referring to FIG. 1, a conventional horizontal-axis wind turbine apparatus is shown and includes an upright prop 31, an electrical generator 32 mounted on a top of the upright prop 31, and three vanes 33 coupled to the electrical generator 32. The vanes 33 are equiangularly spaced apart from one another about a horizontal axis (not shown). To enhance conversion efficiency, the vanes 33 are generally made elongate. When wind in a direction (X) propels rotation of the vanes 33, a wind shear effect in a direction (Y) may be generated to cause noise. In order to reduce the wind shear effect and the noise, the vanes 33 are designed to have converged ends distal from the electrical generator 32 at the cost of reduced overall operation efficiency.

### SUMMARY

Therefore, an object of the disclosure is to provide a vane device for a wind turbine apparatus that can alleviate at least one of the drawbacks of the prior arts.

According to the disclosure, the vane device is adapted for use in a wind turbine apparatus and includes a rotary shaft that is rotatable in a rotational direction, and a plurality of vane units that are angularly spaced apart from each other relative to the rotary shaft.

Each of the vane units includes a grid frame and a plurality of vanes.

Each of the vanes is disposed adjacent to a respective one of the grid spaces, and has a connecting end that is pivotally connected to the grid frame, and a swing end that is opposite to the connecting end. Each of the vanes is swingable between a cover position, where the swing end is adjacent to the grid frame to cover the respective one of the grid spaces, and an open position, where the swing end is away from the grid frame to uncover the respective one of the grid spaces.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a conventional horizontal-axis turbine apparatus;

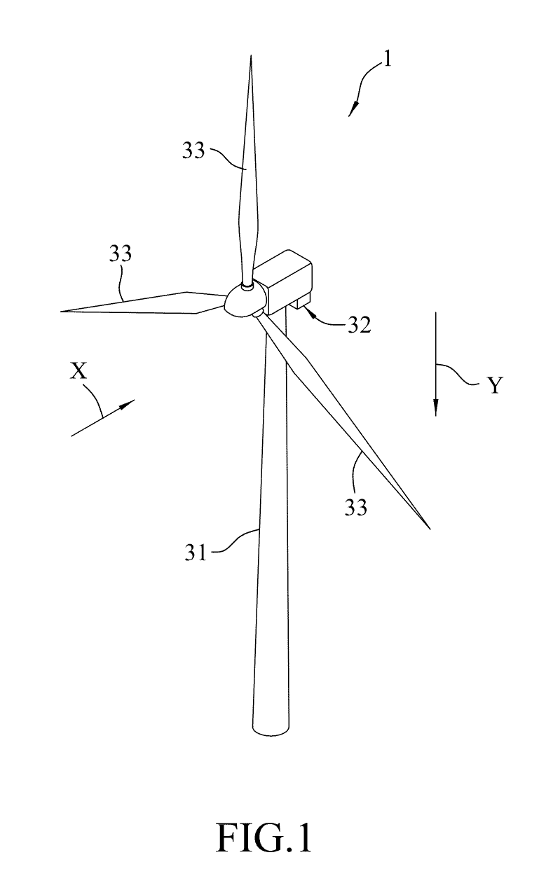

FIG. 2 is a perspective view of a first embodiment of a vane device according to the present disclosure;

FIG. 3 is a perspective view illustrating operation of the first embodiment;

FIG. 4 is an enlarged fragmentary perspective view of FIG. 3;

FIG. 5 is a perspective view of a second embodiment of a vane device according to the present disclosure;

FIG. 6 is a perspective view illustrating operation of the second embodiment;

FIG. 7 is a side sectional view of a vane unit of the first embodiment; and

FIG. 8 is a side sectional view of a vane unit of the second embodiment.

### DETAILED DESCRIPTION

Before the disclosure is described in greater detail, it should be noted that like elements are denoted by the same reference numerals throughout the disclosure.

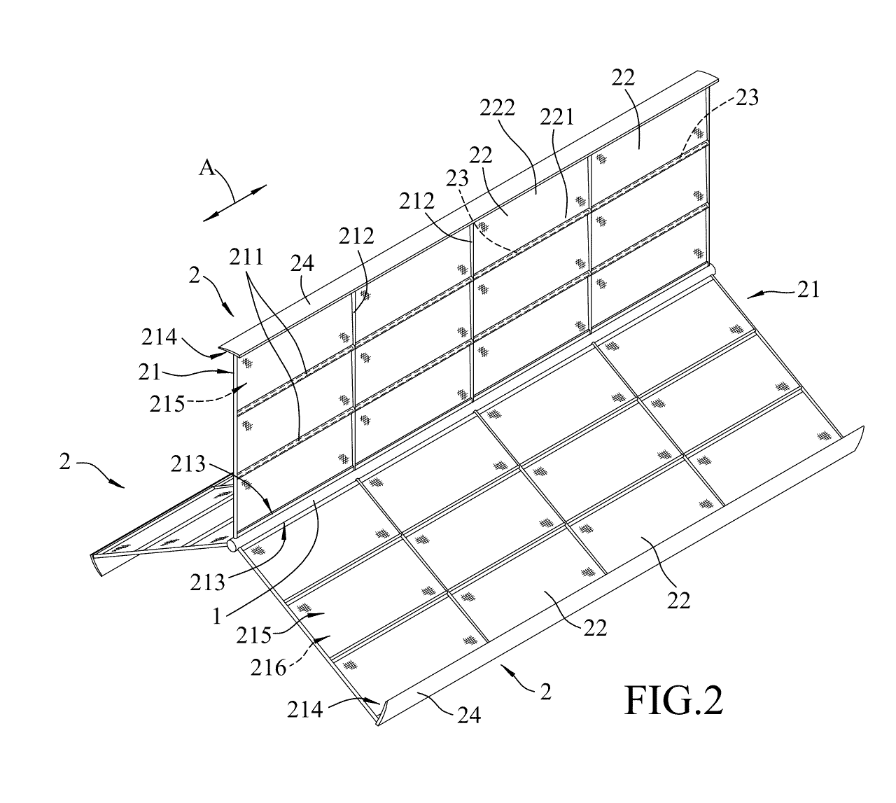

Referring to FIGS. 2 to 4, the first embodiment of a vane device according to the disclosure is adapted for use in a wind turbine apparatus. The vane device includes a rotary shaft 1 and three vane units 2.

The rotary shaft 1 extends horizontally and is rotatable in a rotational direction (T).

The vane units 2 are equiangularly spaced apart from one another relative to the rotary shaft 1. Each of the vane units 2 includes a grid frame 21, a plurality of vanes 22, a plurality of counterweight members 23 and a block member 24.

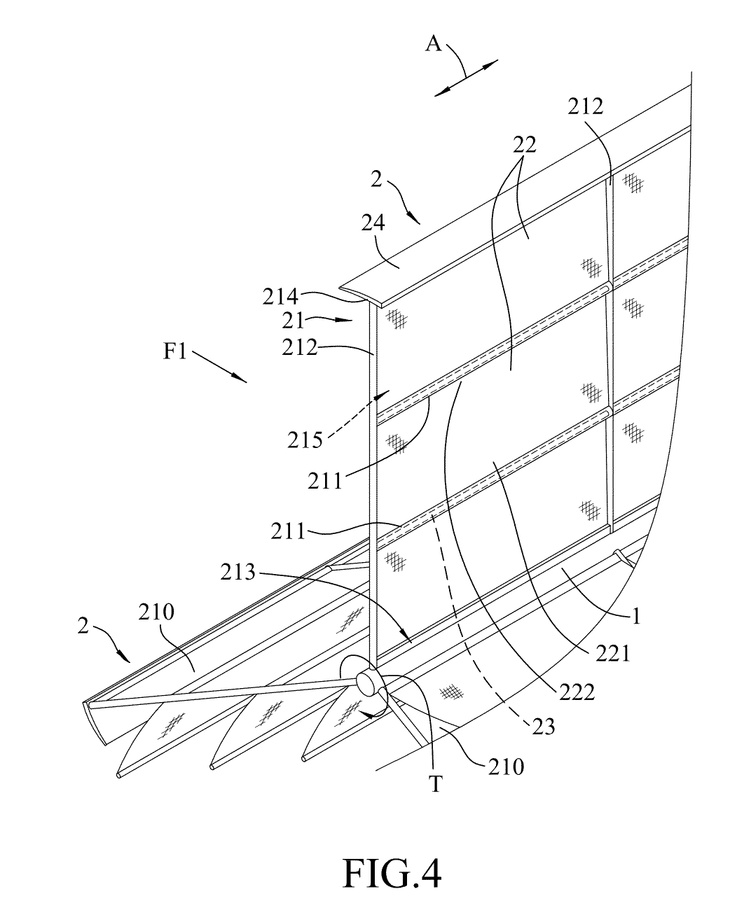

The grid frames 21 of the vane units 2 are spaced 120 degrees apart from each other. For each of the vane units 2, the grid frame 21 is connected to the rotary shaft 1 and has a plurality of grid spaces 210. In this embodiment, the grid frame 21 of each of the vane units 2 has a plurality of first grid rods 211 that extend in an axial direction (A) parallel to the rotary shaft 1 and that are mutually spaced apart in a radial direction with respect to the rotary shaft 1, and a plurality of second grid rods 212 that extend in the radial direction and that are mutually spaced apart in the axial direction (A). The first grid rods 211 and the second grid rods 212 cooperatively define the grid spaces 210. As shown in FIGS. 2 and 4, the grid frame 21 of each of the vane units 2 has an inner end portion 213 that is connected to the rotary shaft 1 and that extends in the axial direction (A), and an outer end portion 214 that is distal from the rotary shaft 1 and that is opposite to the inner end portion 213.

For each of the vane units 2, each of the vanes 22 is disposed adjacent to a respective one of the grid spaces 210, and has a connecting end 221 that is pivotally connected to the grid frame 21, and a swing end 222 that is opposite to the connecting end 221. Specifically, for each of the vanes 22, the connecting end 221 is pivotally connected to one of the first grid rods 211, and the swing end 222 is capable of abutting against an upwind side (i.e., aside to face toward a wind force (F1)) of another one of the first grid rods 211 which is farther from the rotary shaft 1, and which is adjacent to the one of the first grid rods 211. The connecting end 221 of each of the vanes 22 may be pivotally connected to a pivot rod (not shown) that is connected between two lugs (not shown) mounted on the one of the first grid rods 211. However, the connection between each of the vanes 22 and the one of the first grid rods 211 may vary in other embodiments of the disclosure.

In this embodiment, each of the vanes 22 may be a hard sheet which is made from one of metal, fiberglass, hard plastic or hard polymer material, or may alternatively be a soft sheet which is made from one of a cloth, rubber, soft plastic or soft polymer material.

For each of the vane units 2, the counterweight members 23 are respectively coupled to the swing ends 222 of the vanes 22 so as to facilitate pivot movement of the vanes 22.

For each of the vane units 2, the block member 24 is an elongate plate that has a curved cross-section, that is coupled to the outer end portion 214 of the grid frame 21 and that extends from the outer end portion 214 in a direction opposite to the rotational direction (T).

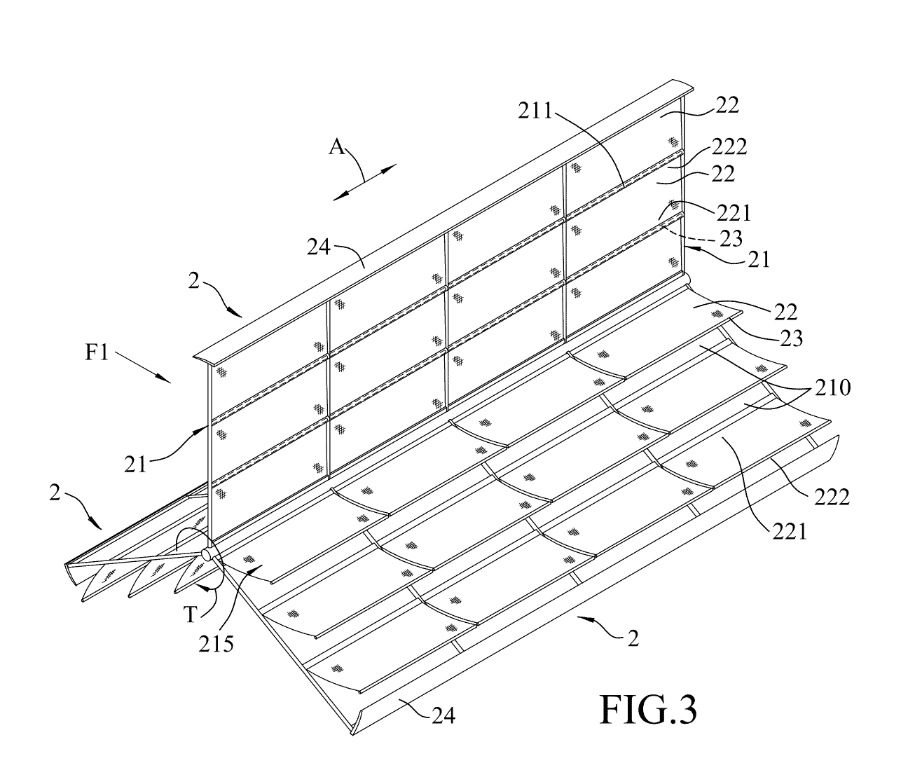

In actual use, each of the vanes 22 is swingable between a cover position (see FIG. 2), where the swing end 222 is adjacent to the grid frame 21 to cover the respective one of the grid spaces 210, and an open position (see the lower two of the vane units 2 shown in FIGS. 3 and 4), where the swing end 222 is away from the grid frame 21 to uncover the respective one of the grid spaces 210 for allowing air flow to pass through the respective one of the grid spaces 210.

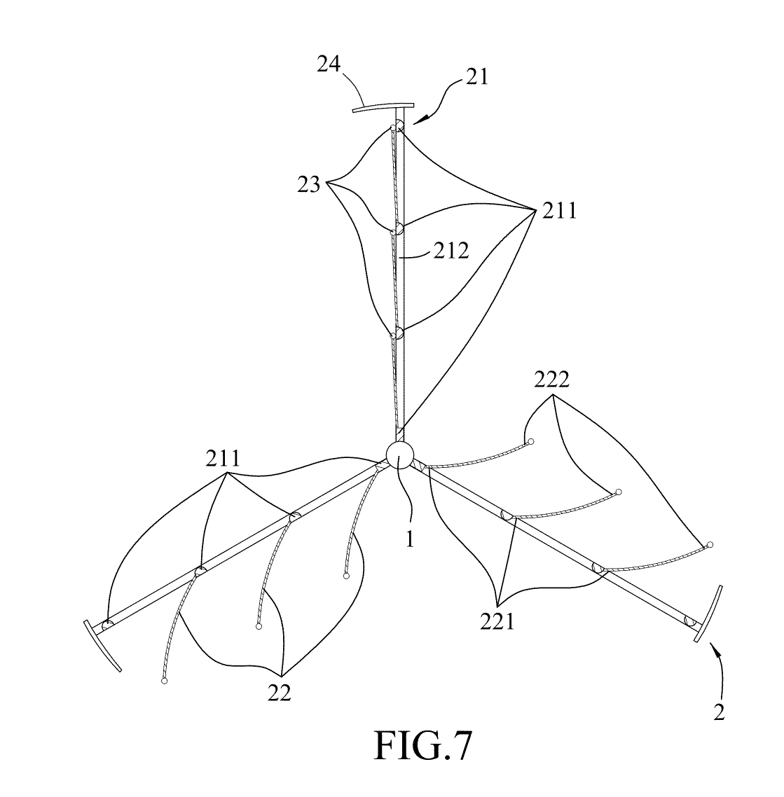

Specifically, the rotary shaft 1 can be disposed only a few meters above the ground while the wind turbine apparatus properly operates by difference of wind pressures on the vanes 22 at different heights. When an upwind region 215 of the grid frame 21 of one of the vane units 2 (i.e., the upper one of the vane units 2 shown in FIGS. 2 to 4 and 7) is brought to face the wind, the vanes 22 of the one of the vane units 2 are driven by the wind force (F1) to the cover position to cover the grid spaces 210 of the grid frame 21 with the swing ends 222 thereof abutting against the corresponding upwind sides of the first grid rods 211. As such, with the vanes 22 of the one of the vane units 2 being held at the cover position, the vanes 22 of the one of the vane units 2 cooperatively form an integral upwind surface for the wind force (F1) to act on to have torque on the rotary shaft 1 for rotating the rotary shaft 1 in the rotational direction (T). The counterweight members 23 of the one of the vane units 2 facilitate abutment of the swing ends 222 of the corresponding vanes 22 against the corresponding upwind sides of the first grid rods 211.

Meanwhile, the upwind regions 215 of the grid frame 21 of the other two of the vane units 2 (i.e., the lower two of the vane units 2 shown in FIGS. 2 to 4) face away from the wind force (F1), so that the vanes 22 of the other two of the vane units 2 swing to the open positions. Accordingly, reverse torque and wind drag caused by the wind force (F1) on the other two of the vane units 2 are reduced. That is to say, the abovementioned force difference propels the three vane units 2 to rotate in the rotational direction (T), thereby increasing efficiency to utilize the wind power.

Further, the block member 24 of each of the vane units 2 can limit the wind flow. When the upwind region 215 of the grid frame 21 of the one of the vane units 2 faces the wind, since each of the vanes 22 are in the cover position, the block member 24 of the one of the vane units 2 would guide the wind flow toward the integral upwind surface formed by the vanes 22 for propelling the one of the vane units 2 and enhancing the torque.

In addition, since a torque acted on a spot of the one of the vane units 2 is smaller than that acted on a farther spot of the one of the vane units 2 with respect to the rotary shaft 1, the vanes 22 axially farther from the rotary shaft 1 can be designed smaller, and the vanes 22 axially from a vicinity of the rotary shaft 1 can be designed larger. In some embodiments, guiding plates (not shown) may be included to assist with collection and guidance of the air flow of the wind toward the integral upwind surface.

To sum up, for each of the vane units 2, since each of the vanes 22 is configured to be swingable between the cover and open positions, the wind force difference can act on the vane units 2 to operate the vane device of this disclosure with less reverse torque and wind drag. In addition, compared with the vanes of the conventional wind turbine apparatus which has to be disposed greater than ten meters from the ground, the vane device of this disclosure can be settled only a few meters from the ground, thereby reducing fabrication and material cost. Further, by virtue of the structural configuration of the vane units 2, the vane device of this disclosure can be operated with less noise.

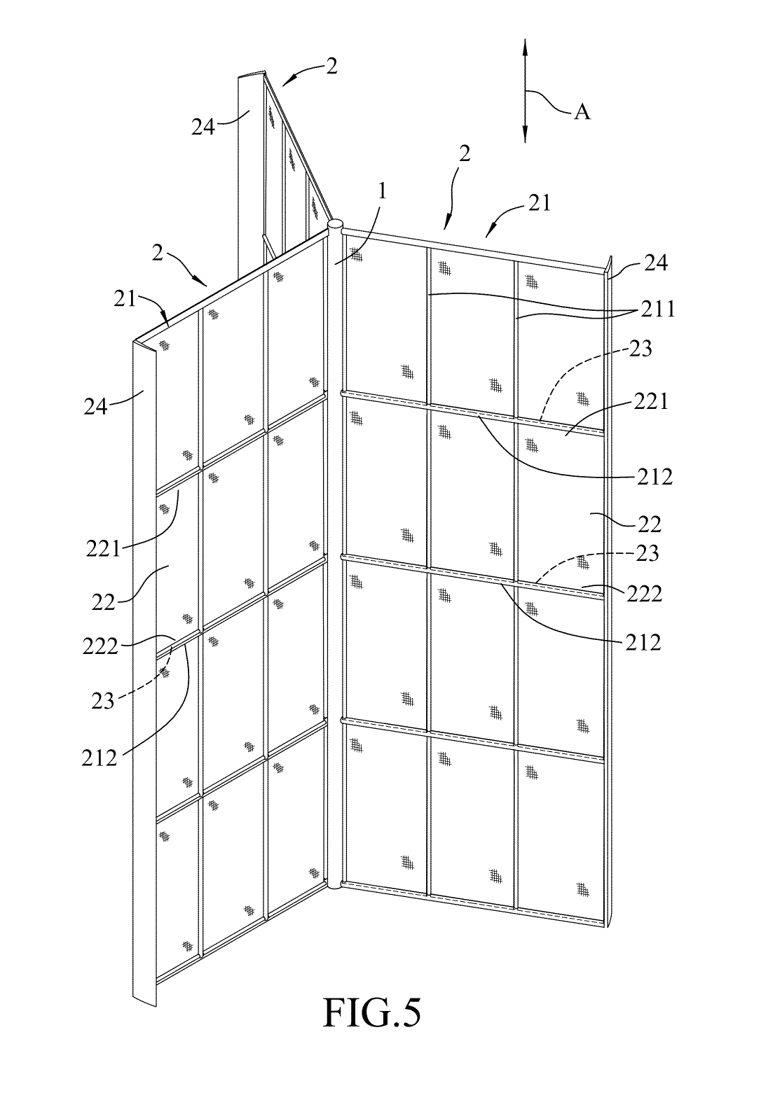

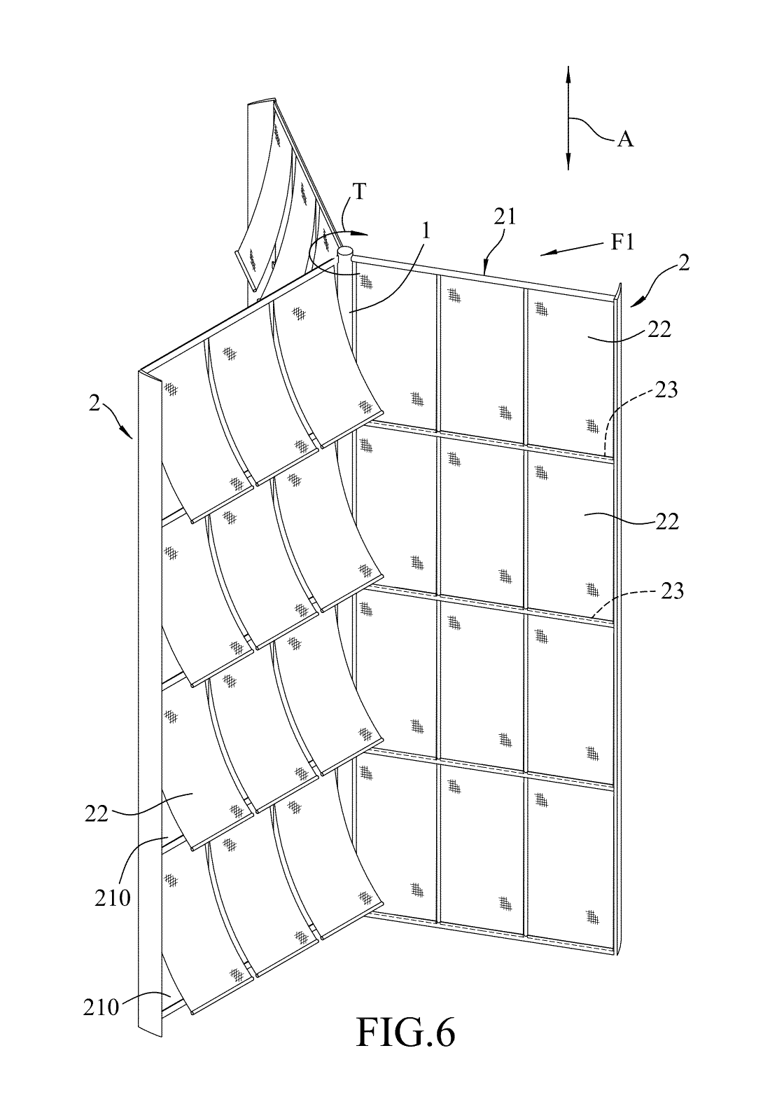

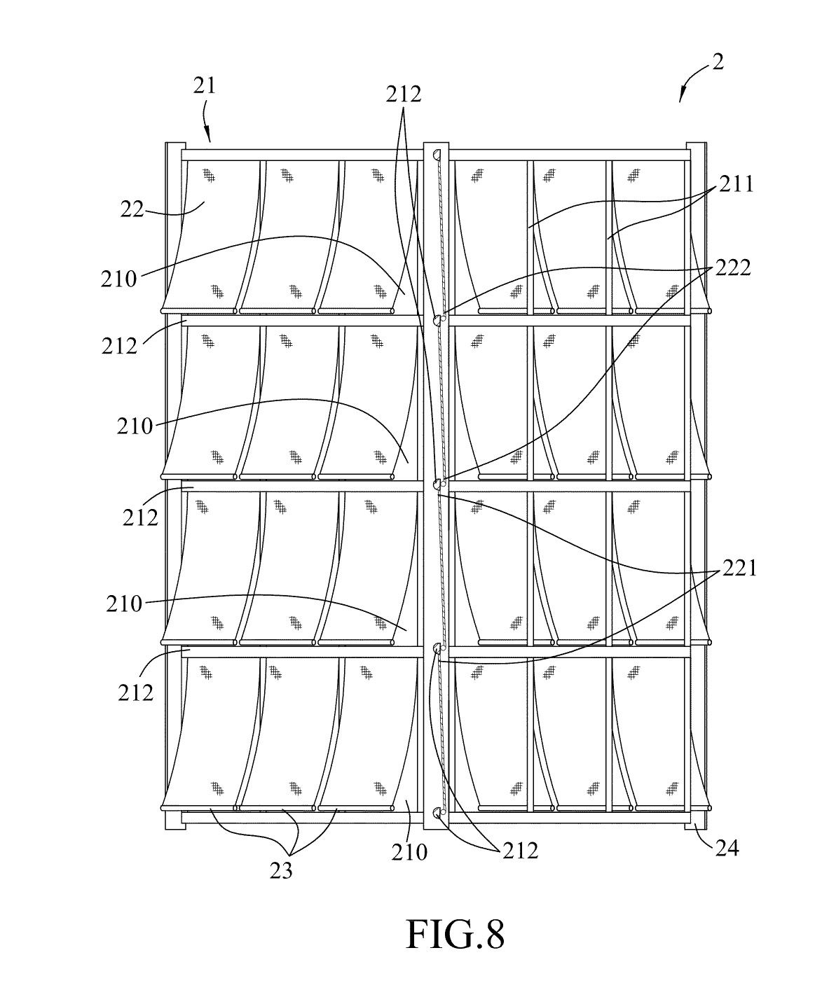

FIGS. 5, 6 and 8 illustrate the second embodiment of a vane device according to the present disclosure, which has a configuration similar to that of the first embodiment. Some differences between the first and second embodiments are depicted hereinafter. In the second embodiment, the rotary shaft 1 extends vertically. For each of the vanes 22, the connecting end 221 is connected pivotally to one of the second grid rods 212, and the swing end 222 is capable of abutting against an upwind side of another one of the second grid rods 212 which is adjacent to and vertically under the one of the second grid rods 212. The counterweight members 23 of the one of the vane units 2 facilitate abutment of the swing ends 222 of the corresponding vanes 22 against the corresponding upwind sides of the second grid rods 212.

In actual use, the second embodiment has the same advantages as those of the first embodiment.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A vane device adapted for use in a wind turbine apparatus, said vane device comprising:
a rotary shaft that is rotatable in a rotational direction; and
a plurality of vane units that are angularly spaced apart from each other relative to said rotary shaft, each of said vane units including
a grid frame that is connected to said rotary shaft and that has a plurality of grid spaces, and
a plurality of vanes, each of said vanes being disposed adjacent to a respective one of said grid spaces, and having a connecting end that is pivotally connected to said grid frame, and a swing end that is opposite to said connecting end, each of said vanes being swingable between a cover position, where said swing end is adjacent to said grid frame to cover the respective one of said grid spaces, and an open position, where said swing end is away from said grid frame to uncover the respective one of said grid spaces.

2. The vane device as claimed in claim 1, wherein each of said vane units further includes a plurality of counterweight members that are respectively coupled to said swing ends of said vanes.

3. The vane device as claimed in claim 1, wherein said grid frame of each of said vane units has an inner end portion that is connected to said rotary shaft, and an outer end portion that is distal from said rotary shaft and that is opposite to said inner end portion, each of said vane units further having a block member that is coupled to said outer end portion of said grid frame and that extends in a direction opposite to the rotational direction.

4. The vane device as claimed in claim 1, wherein said grid frame of each of said vane units includes a plurality of first grid rods that extend in an axial direction parallel to said rotary shaft and that are mutually spaced apart in a radial direction with respect to said rotary shaft, and a plurality of second grid rods that extend in the radial direction and that are mutually spaced apart in the axial direction, said first grid rods and said second grid rods cooperatively defining said grid spaces.

5. The vane device as claimed in claim 4, wherein:
said rotary shaft extends horizontally; and
for each of said vanes, said connecting end is pivotally connected to one of said first grid rods, and said swing end is capable of abutting against an upwind side of another one of said first grid rods which is farther from said rotary shaft, and which is adjacent to said one of said first grid rods.

6. The vane device as claimed in claim 4, wherein:
said rotary shaft extends vertically; and
for each of said vanes, said connecting end is connected pivotally to one of said second grid rods, and said swing end is capable of abutting against an upwind side of another one of said second grid rods which is adjacent to and vertically under said one of said second grid rods.
